(19) United States
(12) Patent Application Publication
(10) Pub. No.: US 2009/0077106 A1
(43) Pub. Date: Mar. 19, 2009

(54) COMPONENT DATA DISTRIBUTION METHOD, COMPONENT DATA DISTRIBUTION APPARATUS, AND PROGRAM THEREOF

(76) Inventors: Takeyuki Kawase, Saga (JP); Hiroshi Okamura, Kyoto (JP)

Correspondence Address: WENDEROTH, LIND & PONACK L.L.P., 2033 K. STREET, NW, SUITE 800, WASHINGTON, DC, 20006, US

(21) Appl. No.: 12/297,359

(22) PCT Filed: Jun. 5, 2007
(86) PCT No.: PCT/JP2007/061689

§ 371 Date: Oct. 16, 2008

(30) Foreign Application Priority Data
Jun. 7, 2006 (JP) 2006-158741
Jun. 9, 2006 (JP) 2006-161154

(51) Int. Cl. G06F 17/30

(52) U.S. Cl. 707/100; 707/E17.009

(57) ABSTRACT

A component data distribution method which is executed by a server device (10) and allows distribution of component data between a plurality of terminal devices (20) when a component is mounted on a board includes: a component data collecting step of collecting component data and evaluation data indicating a degree of an operation required to achieve actual production using the component data from a first terminal device; and a component data accumulating step of accumulating the collected component data with the collected evaluation data so as to provide the collected component data for a second terminal device different from the first terminal device.

### TECHNICAL FIELD

The present invention relates to a component data distribution method and the like which allows distribution of component data to be used by a component mounting device when a component is mounted on a board, and more specifically to a technique of activating the distribution of the component data.

### BACKGROUND ART

Conventionally, regarding a component mounting device for mounting components on a board, a service providing method of providing various kinds of support data, such as business information, electronic instructions, virtual training, and mounted component data (hereinafter referred to simply as component data), for a user over the Internet is known (for example, refer to Patent Reference 1).

Among these, regarding the component data as the data to be used by a component mounting device when the component is mounted on the board, Patent Reference 1 especially describes holding component data with a record of manufacture of good products in a service providing device, and providing a service receiving device with all the component data or data in a scope specified by the component mounting device, a component type, and so on (paragraph [0153]). Thus, even a beginner operator can perform satisfactory mounting production by receiving the component data in accordance with a type of a component or a circuit board to be used.

The component data can be received from a successful user in manufacturing the good products. To prompt a provision of the component data, it is effective to use a well-known technique of giving an incentive to a provider.

Patent Reference 1: Japanese Patent No. 3662578

### DISCLOSURE OF INVENTION

However, according to the technique of Patent Reference 1, the component data can be distributed only after acquiring a record of manufacture of good products. Therefore, while the quality of distributed component data can be maintained at a high level, the amount of the component data cannot easily increase because of an elaborate operation to be performed until the component data can be successfully distributed.

Furthermore, since the component data completed to acquire the record of manufacture of good products is a result of various devices, trial and error, and ingenuity for each user, there is naturally reluctance in disclosing such precious information to third parties, thereby suppressing distribution of the component data.

The present invention has been developed to solve the above-mentioned problems, and aims at providing a component data distribution method for improving the efficiency of production performed using a component mounting device by prompting and activating the provision and the distribution of the component data.

In order to achieve the above-mentioned object, a component data distribution method which is executed by a component data distribution apparatus and allows distribution of component data to be used by a component mounting device when a component is mounted on a board includes: a component data collecting step of collecting component data and evaluation data indicating a degree of an operation required to achieve actual production using the component data from a first terminal device; and a component data accumulating step of accumulating the collected component data with the collected evaluation data so as to provide the collected component data for a second terminal device different from the first terminal device.

Moreover, the component data distribution method may further include: a component data retrieving step of retrieving, when a retrieval condition is provided from the component data receiving device, one or more pieces of component data from among the collected component data in accordance with the provided retrieval condition, and of transmitting, to the component data receiving device, a retrieval result including a component name specifying each piece of retrieved component data and corresponding evaluation data; and a component data providing step of providing, for the component data receiving device, component data specified by a given component name, when the component data receiving device provides an acquisition request with one or more components' names specified and included in the retrieval result.

The component data providing device can determine evaluation data indicating the lower degree for component data having more number of null items among plural items of the component data as evaluation data collected by the server device. When the component data providing device is realized as a component mounting device, the component mounting device can determine the evaluation data indicating the lower degree when test production using the component data is successfully performed than when it is not successfully performed. The component mounting device can also determine the evaluation data indicating the lower degree when actual production with the component data is successfully performed than when it is not successfully performed.

With the above-mentioned configuration, component data not yet having a record of manufacture of good products and having necessary operations to be performed to achieve actual production is provided for use after being collected with evaluation data indicating the operations. Therefore, the amount of distributed component data increases, and the distribution of the component data can be activated.

In addition, the component data distribution method may further include an incentive determining step of determining an incentive by judging the operation required to achieve the actual production based on contents indicated by the evaluation data. The distribution of the component data can be prompted by giving, to a provider of the component data, the incentive determined depending on the evaluation.

Especially, provision of more practical component data can be prompted by: including a complaint collecting step of collecting complaints indicating problems in the provided component data, and determining a higher incentive in the incentive determining step for the smaller number of collected complaints; determining in the incentive determining step a lower incentive when other component data similar to the component data has already been collected than when it has not been collected; or determining in the incentive determining step the higher incentive for the more difficult or troublesome operations required in generating the component data.

Furthermore, it is preferable that the component data distribution method also includes an incentive accumulating step of accumulating an incentive determined by associating it with the provider of the component data, and the component data providing method includes an incentive displaying step of displaying the incentive.

With the configuration, a component data provider can be encouraged to have a practical motivation to provide the component data.

Additionally, the component data distribution method may further include a use fee payment instruction notifying step of notifying the component data receiving device of a use fee payment instruction based on the collected evaluation data of the collected component data when the collected component data is provided for the component data receiving device.

Since the efficiency of collecting a use fee as a source of the incentive can be improved with the above-mentioned configuration, the provision of the component data can be smoothly prompted by the incentive.

Moreover, the component data distribution method may further include a component data providing step of providing the collected component data for only a user in a scope set by a provider of the component data.

With the above-mentioned configuration, since the provider of the component data can limit the scope of disclosure of components to be registered, the reluctance in providing the component data caused by the disclosure of the precious component data widely to general users can be reduced. As a result, it is expected that the distribution of the component data can be prompted within the limited scope of the disclosure. Furthermore, for example, it is convenient that a practical application can be realized by registering the component data to be disclosed only to users of related companies and the like.

Preferably, the component data also includes a portion common to a plurality of component mounting devices, and a plurality of portions individualized to the plurality of component mounting devices; and, in the component data collecting step, the component data is collected with a plurality of pieces of evaluation data individualized to the plurality of component mounting devices. Thus, the evaluation of component data can be managed for each component mounting device.

Moreover, when the component data providing device is realized as the component mounting device, in the component data collecting step, component data having a production record in the component mounting device may be collected by the component data distribution apparatus by issuing, to the component mounting device, a notification for prompting a provision of the component data having the production record.

With the above-mentioned configuration, component data with a production record can be collected at a high probability directly from the component mounting device.

Moreover, when the component data receiving device is realized as the component mounting device, in a component data providing step, the component mounting device may be provided with the component data in accordance with an acquisition request transmitted from the component mounting device when the components are collated.

Since necessary component data can be provided from the server device with the above-mentioned configuration when the data is required by the component mounting device, the efficiency of production performed using the component mounting device can be improved.

When the component data receiving device is realized as the component mounting device, the server device can provide the component data free of charge for the component mounting device in the component data providing step.

With the configuration, a merit of introducing the component mounting device can be appealing to potential clients by emphasizing that the component data is provided free of charge.

The present invention can be not only realized as the above-mentioned component data distribution method and component data providing method, but also realized as an apparatus for performing the methods, a system or a program including the apparatus, and a storage medium storing the program.

According to the component data distribution method, the component data providing method and the like of the present invention, component data having no record of manufacture of good products and having necessary operations to be performed to achieve actual production can be distributed with evaluation data indicating the operations. Therefore, a user of the component mounting device can check the evaluation data and determine whether or not the component data can be immediately used, to what extent it is necessary to make adjustments to the component mounting device and so on. Consequently, the distribution of the component data can be activated, and the component data can be quickly improved up to the level at which the component data can be used for manufacture of good products. The provision of the component data can be prompted by the incentive depending on the evaluation and the use situation.

Thus, since component data of various levels of evaluation can be collected by a server device as a component data distribution apparatus and be distributed, there is the increasing number of opportunities for a component mounting device to acquire available component data. An operator can select and acquire component data of necessary evaluation by confirming the evaluation of the component data to be acquired when the operator acquires the component data.

As a result, an operation of adjusting the component data by trial and error, and an operation of improving the component data by an analysis of a problem can be reduced. Therefore, the production resources required in the trial step up to the manufacture of good products can be optimized. The optimization of the production resources corresponds to the reduction of, for example, the number of working steps of an operator, electric power, fuels, water, sample materials and so on.

Furthermore, using component data of desirable evaluation (that is, data well-examined and completed at a high level) acquired from the server device, the quality of a product manufactured in a step of manufacture of good products can be enhanced. As a result, the product needs reduced power consumption and has extended durability, thereby contributing to socially required energy- and resource-saving.

Further Information about Technical Background to this Application

The disclosure of Japanese Patent Application No. 2006-158741 filed on Jun. 7, 2006 including specification, drawings and claims is incorporated herein by reference in its entirety.

The disclosure of Japanese Patent Application No. 2006-161154 filed on Jun. 9, 2006 including specification, drawings and claims is incorporated herein by reference in its entirety.

### BRIEF DESCRIPTION OF DRAWINGS

FIG. 1 shows an outline of a configuration of a component data distribution system according to an embodiment of the present invention;

FIG. 2 is a block diagram showing an example of a functional configuration of a server device and a terminal device;

FIG. 3 is a top view showing an example of a component;

FIGS. 4A and 4B show an example of component data stored in a component data storage unit 11 and a component data storage unit 23;

FIG. 5 shows an example of a recognized portion of an image;

FIGS. 6A and 6B are explanatory views of evaluation data;

FIG. 7A shows an example of a component from which component data is generated with relatively high difficulty, and FIG. 7B shows an example of a recognized portion of a image of the component;

FIG. 8 shows an example of an incentive table 160;

FIG. 9 is a flowchart showing a detailed operation of a server device 10;

FIG. 10 is a flowchart showing a detailed operation of a terminal device 20;

FIG. 11 shows an example of a display screen of a detection result;

FIG. 12 shows an example of an input screen of shape data;

FIG. 13 shows an example of an input screen of mounting data;

FIG. 14 shows an example of a registration prompt screen of component data; and

FIG. 15 shows an example of a transmission confirmation screen of a complaint.

### NUMERICAL REFERENCES

| | |
|---|---|
| 1 | Component data distribution system |
| 10 | Server device |
| 11 | Component data storage unit |
| 12 | Component data supply unit |
| 13 | Communication I/F unit |
| 14 | Component data collection unit |
| 15 | Incentive determination unit |
| 16 | Incentive accumulation unit |
| 20 | Terminal device |
| 21 | Mounting control unit |
| 22 | Operator I/F unit |
| 23 | Component data storage unit |
| 24 | Communication I/F unit |
| 25 | Mounting mechanism unit |
| 26 | Component data input unit |
| 27 | Evaluation determination unit |
| 28 | Component data registration unit |
| 30 | Network |
| 110 | Common portion |
| 111 | Model-dependent portion |
| 121 | Retrieval unit |
| 122 | Use data storage unit |
| 150 | Operation necessity table |
| 151 | Evaluation table |
| 160 | Incentive table |
| 211 | Component data acquisition unit |
| 212 | Complaint transmission unit |

### BEST MODE FOR CARRYING OUT THE INVENTION

An embodiment of the present invention is described below in detail by referring to drawings.

### <System Configuration>

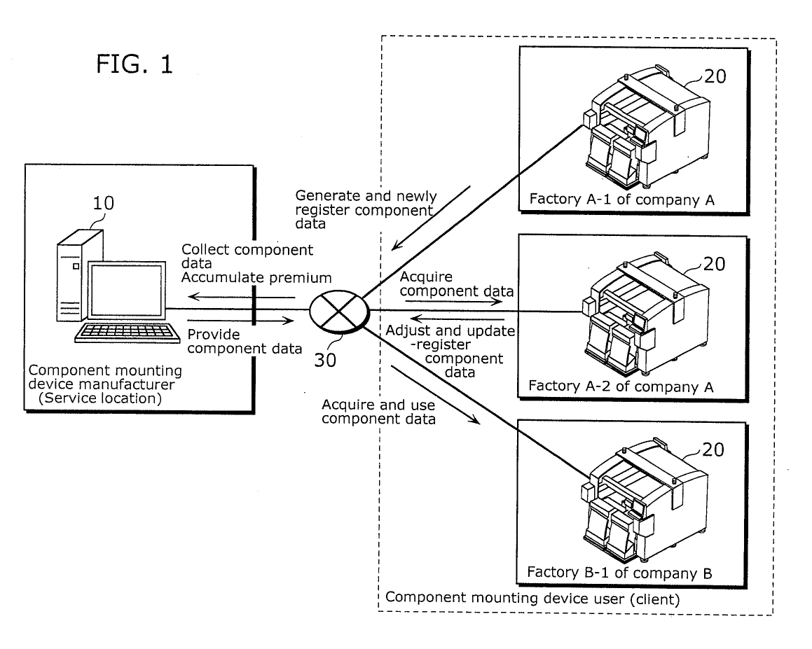

FIG. 1 shows an outline of a configuration of a component data distribution system according to the embodiment of the present invention.

A component data distribution system 1 is configured by connecting a server device 10 and a plurality of terminal devices 20 via a network 30. The server device 10 is an example of a component data distribution apparatus, and the terminal device 20 is an example of a component data providing device.

In FIG. 1, the server device 10, as an example, is a computer provided at a service location of a component mounting device manufacturer, and each terminal device 20, as an example, is realized as a component mounting device provided in a factory of a component mounting device user.

In such configured component data distribution system 1, component data is distributed by the server device 10 and the plurality of terminal devices 20 exchanging the component data via the network 30. The component data is a type of data used by a component mounting device when a component is mounted on a board, and includes data determining, for each type of models of the component mounting device, a device condition for optimizing the error in mounting the component in addition to the data related to the component itself such as the measurement of the component. The component data is instructed to the component mounting device with the NC data practically indicating which component is to be mounted at which point on the board in which order, and is used in controlling the component mounting device when the component is mounted on the board.

The server device 10 collects and registers the component data provided by a first terminal device by prompting the first terminal device as one of the terminal devices 20 to provide the component data. Then, the server device 10 provides a second terminal device different from the first terminal device with the registered component data. The second terminal device receives the component data provided from the server device 10, and uses the received component data. Thus, the server device 10 distributes the component data.

Therefore, the server device 10 functions as the component data distribution apparatus for distributing the component data, and also functions as the component providing device for providing the component data for the second terminal device. The first terminal device functions as the component data providing device for providing the component data for the server device 10. The second terminal device functions as the component data receiving device for receiving the component data from the server device 10.

In distributing the component data, for example, the terminal device 20 of Factory A-1 of Company A transmits the component data generated by the terminal device 20 to the server device 10 of a service location together with the evaluation data, and the server device 10 receives and newly registers the component data.

The evaluation data indicates the degree of the operation required to achieve the actual production using the component data. That is, the evaluation data is an index indicating what is lacking in the current component data, and what operation is required in, for example, an adjusting operation to improve the current component data up to the stage of realizing the manufacture of good products.

At this time, the terminal device 20 is permitted to transmit, to the server device 10, the component data which is indicated by the evaluation data so as to require an operation to successfully manufacture good products and achieve the actual production.

The component data newly registered in the server device 10 is acquired by the component mounting device of Factory A-2 of Company A, complemented and adjusted depending on the evaluation to manufacture good products, and then transmitted to the server device 10 together with new evaluation data after successfully manufacturing the good products. The server device 10 updates the registration of the component data after the adjustment.

The adjusted component data whose registration is updated in the server device 10 is acquired by the component mounting device of Factory B-1 of Company B, and directly used for the manufacture of good products.

The new registration and updated registration of the component data are prompted by the incentive given to a provider of the component data depending on the evaluation. The given incentive is associated with the provider of the component data, and accumulated in the server device 10.

### <Configuration of Server Device and Terminal Device>

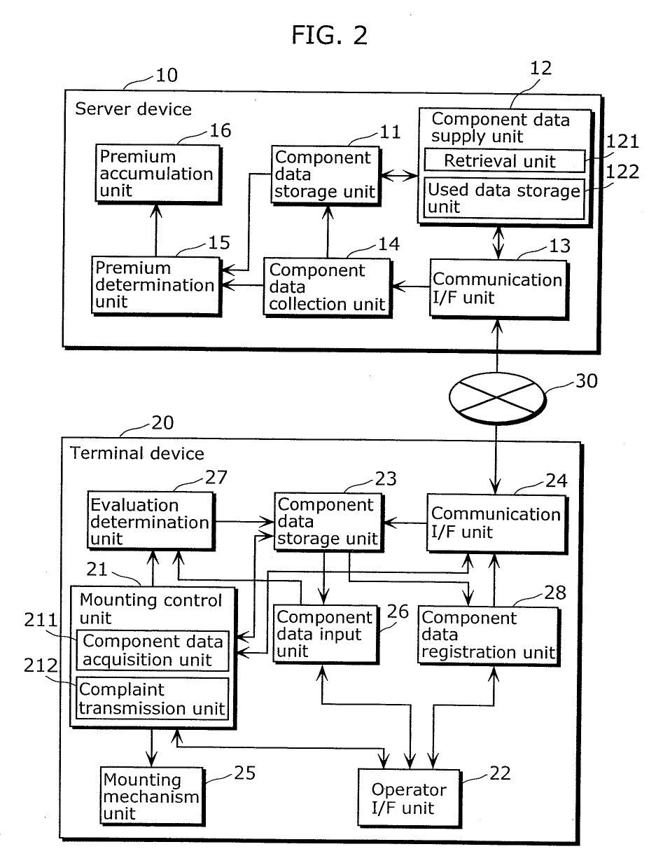

FIG. 2 is a block diagram of an example of a configuration showing a function of the server device 10 and the terminal device 20. FIG. 2 also shows the network 30 connecting the server device 10 and the terminal device 20.

The server device 10 collects component data and corresponding evaluation data from the terminal device 20, and provides the collected component data to one of the terminal devices 20, and configured by a component data storage unit 11, a component data supply unit 12, a communication I/F (interface) unit 13, a component data collection unit 14, an incentive determination unit 15, and an incentive accumulation unit 16. The component data supply unit 12 includes a retrieval unit 121 and a use data storage unit 122.

The component data collection unit 14 receives the component data and the corresponding evaluation data from the terminal device 20, and stores the received component data and the evaluation data in the component data storage unit 11.

When the retrieval unit 121 receives from the terminal device 20 a retrieval condition specifying a component name, it retrieves, from the component data storage unit 11, one or more pieces of the component data matching the received retrieval condition. It transmits to the terminal device 20 a detection result including a component name, a model name of a component mounting device, and corresponding evaluation data as an identification key to the retrieved component data.

When the component data supply unit 12 receives, from the terminal device 20, an acquisition request specifying one or more identification keys included in the detection result, it provides the terminal device 20 with the component data identified by the identification key.

When the use data storage unit 122 provides the component data and receives a complaint about the component data from the terminal device 20, it updates use data stored in the component data storage unit 11 and indicating the number of uses of the component data and the number of occurrences of complaints. A complaint about the component data refers to the information about a problem caused by insufficient component data such as information that a component is mounted according to the component data, but the component is not picked up using suction to a mounting head or the component drops from the mounting head during transfer of the component picked up using suction.

The incentive determination unit 15 determines an incentive depending on the evaluation data and the use data stored in the component data storage unit 11 corresponding to the component data, associates the determined incentive with the provider of the component data, and accumulates the resultant data in the incentive accumulation unit 16.

Note that there can be a plurality of providers of the component data for one component name. For example, if a plurality of providers such as a first provider of shape data, a second provider who adds mounting data, a third provider who amends the mounting data up to the stage of performing test production and the stage of achieving actual production and the like complete the component data into the realization of the manufacture of good products in a phased manner, then the incentive is accumulated in the incentive accumulation unit 16 by associating the data with the respective providers.

The communication I/F unit 13 communicates data with the terminal device 20 via the network 30.

The terminal device 20 provides the component data for the server device 10, and acquires and uses the component data already registered in the server device 10. As an example of realizing the device as a component mounting device, it is configured by a mounting control unit 21, an operator I/F unit 22, a component data storage unit 23, a communication I/F unit 24, a mounting mechanism unit 25, a component data input unit 26, an evaluation determination unit 27, and a component data registration unit 28. The mounting control unit 21 includes a component data acquisition unit 211 and a complaint transmission unit 212.

The mounting control unit 21 controls the mounting mechanism unit 25 using the component data stored in the component data storage unit 23, and mounts the component on the board.

The mounting mechanism unit 25 is configured by, for example, a board table for placing a board, a component providing unit for providing each component from a component storage tape storing a plurality of components, a mounting head which picks up a component using suction, transfers it to a target position, and mounts it there, and a camera for recognizing a state in which the component is picked up using suction. Since the mounting mechanism unit 25 is not a subject of the present invention, it is assumed that it is realized by the conventional technique, and the detailed description is omitted here.

When the component storage tape is loaded, the component providing unit performs a collating process of reading a component name from a bar code or an IC tag added to the component storage tape, and notifies the mounting control unit 21 of the read component name.

If the component data storage unit 23 does not store the component data identified by a notified component name and the model name of the component mounting device itself and indicating that actual production has been achieved by evaluation data, then the component data acquisition unit 211 transmits the retrieval condition specifying a component name to the server device 10. Then, it acquires, from the server device 10, a component name and a model name of the component mounting device as the identification key of the component data matching the retrieval condition, and the corresponding evaluation data, and displays the data on the operator I/F unit 22.

The operator I/F unit 22 can be, for example, a liquid crystal display attached to a chassis of the component mounting device, a touch panel mounted on the front surface of the liquid crystal display, a keyboard and the like.

The component data acquisition unit 211 accepts an operation of selecting component data depending on the evaluation through the operator I/F unit 22, and transmits an activation request including an identification key of the selected component data to the server device 10, thereby acquiring the component data identified by the identification key, and storing the component data in the component data storage unit 23.

When the component data input unit 26 does not at all retrieve the component data from the server device 10 or does not acquire component data with sufficient evaluation, it newly generates component data according to the input operation received through the operator I/F unit 22, or supplements and corrects the component data. The newly generated component data or supplemented or corrected component data are stored in the component data storage unit 23.

The mounting control unit 21 performs the test production and actual production using the component data stored in the component data storage unit 23. The component data input unit 26 further performs a rough adjustment and precise adjustment of the component data on the basis of the input operation received through the operator I/F unit 22 at the beginning of the test production and the actual production.

The evaluation determination unit 27 determines evaluation data depending on the status of the component data, and stores the data in the component data storage unit 23. The evaluation determination unit 27 re-determines the evaluation data depending on the change of the status of the component data, and updates the component data storage unit 23. A practical example of an operation required to achieve the actual production depending on the status of the component data and the details of the evaluation data is described later.

When the evaluation data of the component data is determined and updated, the component data registration unit 28 notifies the operator I/F unit 22 of a prompt to register the component data in the server device 10, and registers the component data and the corresponding evaluation data in the server device 10 depending on the response operation of an operator.

### <Component Data>

Component data is described below in detail.

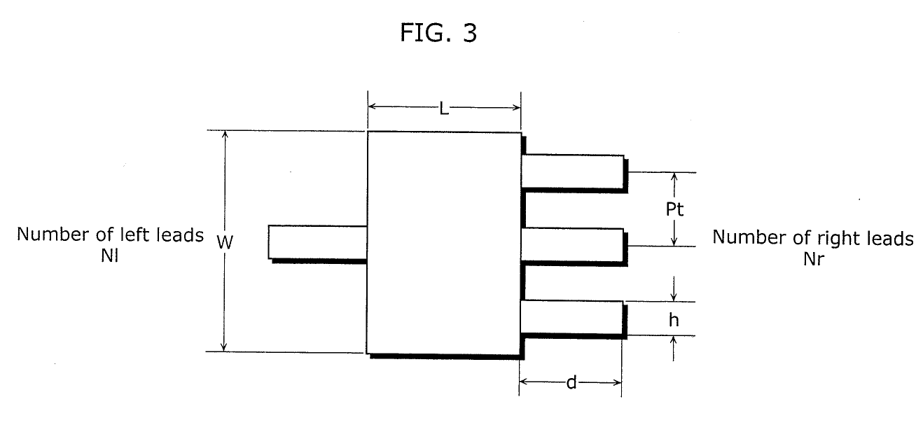

FIG. 3 is a top view showing an example of a component. A body of the component is rectangular as viewed from above, and has leads extending outside from two opposing sides. Shape of all components sharing the characteristics is determined using the same measurement items as shown in FIG. 3.

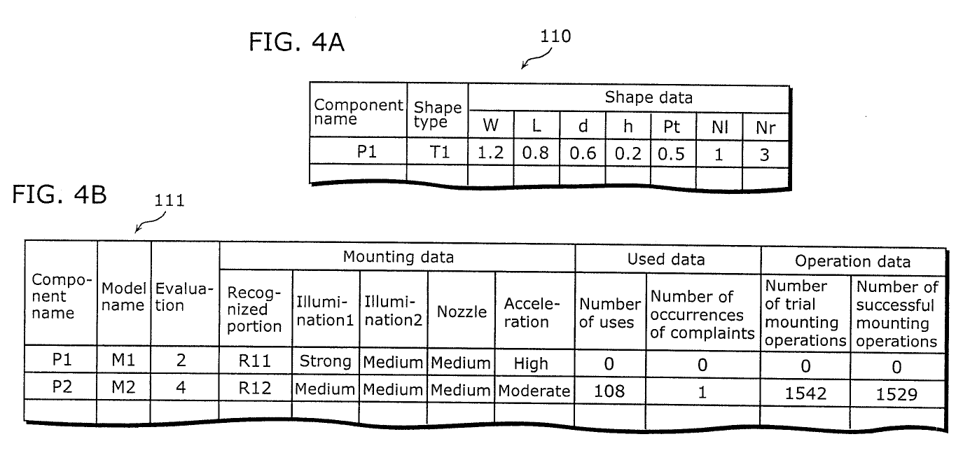

FIGS. 4A and 4B show an example of component data stored in a component data storage unit 11 of a server device 10 and a component data storage unit 23 of a terminal device 20, and show an example related to the component shown in FIG. 3.

FIG. 4A shows a common portion 110 independent of a model of a component mounting device for the component data, and shows shape data indicating measurements of the component as an example. One component has one common portion.

The shape type indicates characteristic shape of the component, and each item of the shape data shows the measurements of each portion appearing in the top view of the component shown in FIG. 3. It is also possible to assume that all components whose shapes are determined with the same measurement items are assigned to the same shape type.

FIG. 4B shows a model-dependent portion 111 which depends on the model of the component mounting device for the component data, for example, mounting data for device condition for minimizing the error in mounting the component, use data indicating the number of uses of the component data and the number of occurrences of complaints, and operation data indicating the number of mounting trial operations and the number of successful operations of the component mounting device. One component can have a model-dependent portion of the number of models of component mounting devices, being applied to the component mounting devices.

Evaluation data is recorded in the model-dependent portion.

In the mounting data, a recognized portion is determined as a reference for detecting that a component is not picked up using to a right position. The illumination 1 and 2 determine the optimum illumination intensity for recognition of the component, and the nozzle and the transfer acceleration respectively determine the optimum condition for picking up using suction and transferring the component by a mounting head.

Items of operation data can be omitted in the component data storage unit 11, and those of use data can be omitted in the component data storage unit 23.

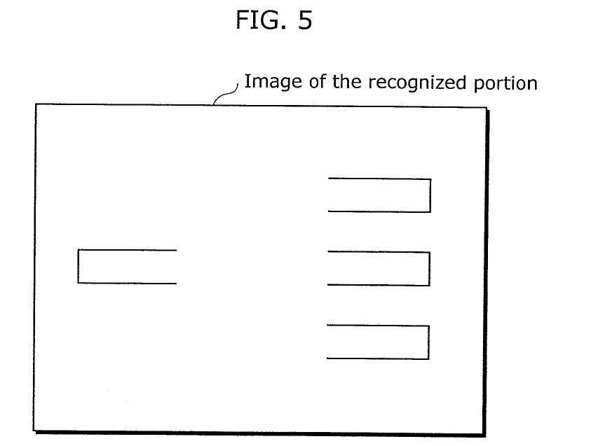

FIG. 5 shows an example of an image of the recognized portion. The image of the recognized portion R11 shown in this example determines the lead position displayed on the image captured when the component shown in FIG. 3 is picked up using suction by the mounting head in accordance with the reference.

The shift between the lead displayed on the image obtained in the actual capturing and the lead displayed on the image of the recognized portion is detected as the component not being picked up using such to the right position, and mounting error can be minimized by correcting the detected shift.

### <Evaluation Data>

Evaluation data is described below in detail.

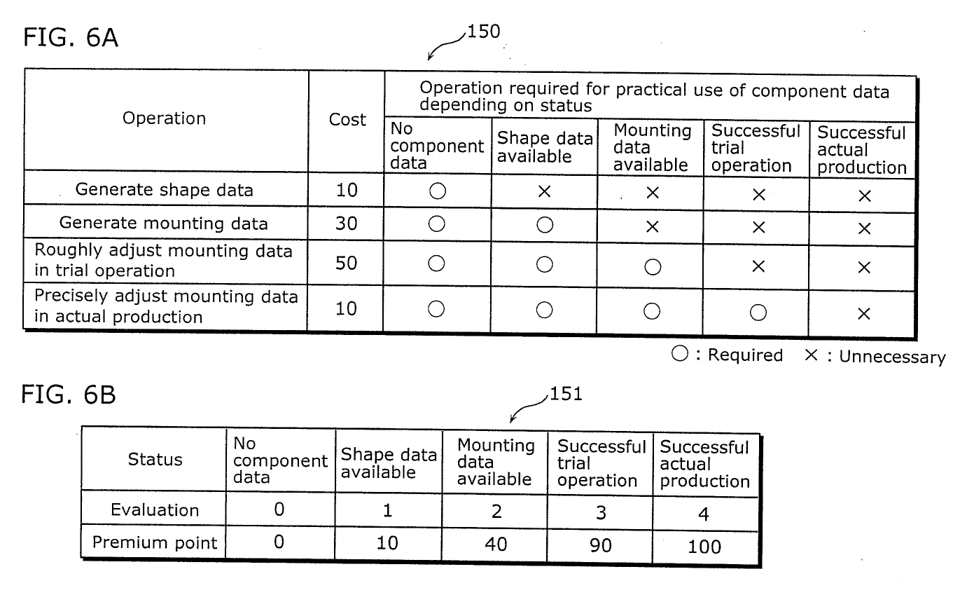

FIGS. 6A and 6B are explanatory views of the evaluation data.

FIG. 6A shows an example of an operation necessity table 150. The operation necessity table 150 is a matrix indicating whether or not each operation is necessary when component data at a corresponding stage is used at a plurality of stages of evaluation of the component data in a plurality of common operations performed on the component data to achieve actual production. Each row of the operation necessity table 150 shows an operation of “generating shape data,” “generating mounting data,” and the like. Each column shows a stage of “no component data,” “shape data available,” and the like. Each intersection of a row and a column is marked with ◯ indicating that the operation is still required when the component data at the stage is used, and x indicating the operation is not necessary.

For example, the intersection of the row of “generating shape data” and the column of “no component data” is marked with ◯, which indicates that when the evaluation of the component data is at the stage of no component data at all (even shape data is present), the operation of “generating shape data” is required.

The intersection of the row of “generating shape data” and the column of “shape data available” is marked with x, which indicates that the operation of “generating shape data” is not required by using the component data when the evaluation of the component data is at the stage of the shape data already generated.

The operation necessity table 150 shows a cost value indicating the complexity and difficulty of each operation. The cost value is reflected by the incentive for provision of the component data as described later.

In this operation, there are four types of practical examples of the above-mentioned operation, that is, a shape data generating operation (a portion common to a mounting device model of component data), a mounting data (model-dependent portion) generating operation, a mounting data roughly adjusting operation in test production, and a mounting data precisely adjusting operation in actual production. The cost value of each operation is set to, for example, 10, 30, 50, and 10 respectively. The stages of the evaluation are practically set to five types, that is, as no component data, shape data available, mounting data available, successful test production, and successful actual production.

At the stage where there is no component data, all operations posterior to generation of the shape data are required to achieve the actual production using the component data. At the stage where there is only the shape data, operations posterior to generation of the mounting data are required. At the stage where the mounting data is available, operations posterior to the mounting data roughly adjusting operation in the test production are required. At the stage of the successful test production, the mounting data precisely adjusting operation in the actual production is required. At the stage of the successful actual production, no operations are required.

The operation necessity table 150 is used for describing the embodiment of the present invention, and may not be always provided for the server device 10 and the terminal device 20.

FIG. 6B shows an example of an evaluation table 151. The evaluation table 151 holds different stage values and incentive points depending on the five above-mentioned evaluation stages. An incentive point indicates a total cost value of the operation (in FIG. 6A, the operation indicated as unnecessary (x) in each stage (column)) assumed as unnecessary on the operation necessity table 150 practically depending on the stage.

The total value indicates the level of complexity and difficulty of an operation assumed to have been assigned to the component data until the evaluation of the component data reaches the current stage, and indicates a practical example of an incentive value. The higher the total value, that is, the higher the stage value of the evaluation, the lower the degree of a necessary operation is indicated to achieve the actual production using the component data.

The evaluation table 151 is provided for an incentive determination unit 15 of the server device 10.

It is preferable that the higher the difficulty of the generation of the component data is, or the higher the complexity is, the above-mentioned incentive point is set to a higher value. Therefore, for example, with the relationship between the difficulty or the complexity in generating the component data and the component shape taken into account, a plurality of evaluation tables 151 are provided for determination of different incentive points for a plurality of shape types indicating different component shapes, and the incentive point can be determined depending on the evaluation table corresponding to the shape type of the component data.

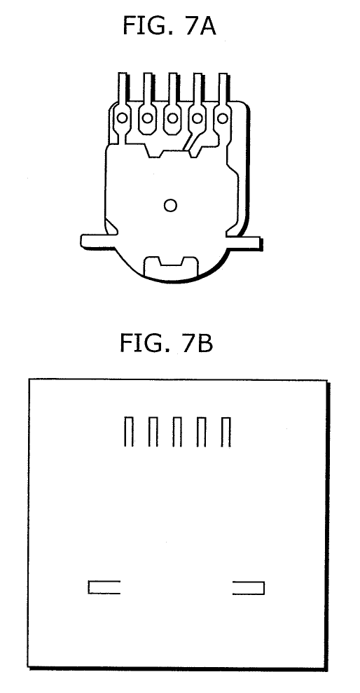

FIG. 7A shows an example of a component from which the component data is generated with relatively high difficulty. FIG. 7B shows an example of the image of the recognized portion of the component. The component is assigned to a shape type different from the shape type of the component shown in FIG. 3. As a common example, a component whose body has a circular shape is assigned to a higher difficulty level because a portion in which an angle shift can be detected with high accuracy cannot be easily set, and a component having a larger number of leads is higher in complexity.

### <Incentive Data>

Incentive data is described below in detail.

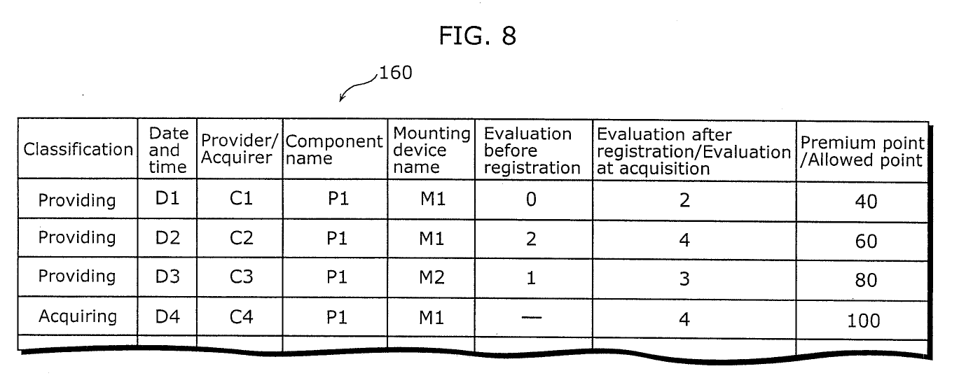

FIG. 8 shows an example of an incentive table 160. The incentive table 160 is provided for the incentive accumulation unit 16 of the server device 10.

The incentive table 160 has the records of new registration and updated registration of component data with each registration date and time, a provider of the component data, a component name and a model name of a component mounting device as the identification key of the component data, the evaluation data before and after registration, and the incentive point fed back to the provider as the incentive data.

Furthermore, the incentive table 160 has the records of acquisition of the component data with each acquisition date and time, an acquirer of the component data, a component name and a model name of a component mounting device as the identification key of the component data, the evaluation data at acquisition, and the imposed point on the acquirer (that is, a use fee) as imposed data.

The records of the incentive data and the imposed data on the incentive table 160 are made by the incentive determination unit 15.

The practical contents of the incentive data and the imposed data stored in the incentive table 160 are described below as examples by referring to the third and fourth rows shown in FIG. 8.

The incentive data in the third row is recorded when the incentive data having the stage value of the evaluation of “1” has already been registered (the evaluation before registration is “1”), and the terminal device 20 registers the component data having the stage value of the evaluation of “3” in the server device 10 (the evaluation after the evaluation is “3”).

Before and after the registration, the incentive point corresponding to the evaluation of the component data increases from “10” to “90” (refer to FIG. 6B). Therefore, the incentive determination unit 15 determines the increment of “80” as the incentive point of the provider “C3,” and records it as the incentive data.

The imposed data on the fourth row is recorded when the terminal device 20 acquires from the server device 10 the component data having the stage value of the evaluation of “4” (the evaluation at registration is “4”).

Since the incentive point corresponding to the evaluation of the acquired component data is “100” (refer to FIG. 6B), the incentive determination unit 15 determines the incentive point of “100” as an imposed point for the acquirer of “C4,” and records it as the imposed data.

By referring to the incentive table 160, the accumulation of the incentive points given to a provider is calculated for each provider, and the accumulation of the imposed points on an acquirer is calculated for each acquirer.

Each acquirer can pay the point obtained by multiplying the imposed point by a predetermined (few percent) fee rate as an actual use fee by considering that the component data is generally acquired and used by a plurality of acquirers.

### <Detailed Operation of Server Device>

Operation of the server device 10 is described below in detail by referring to a flowchart.

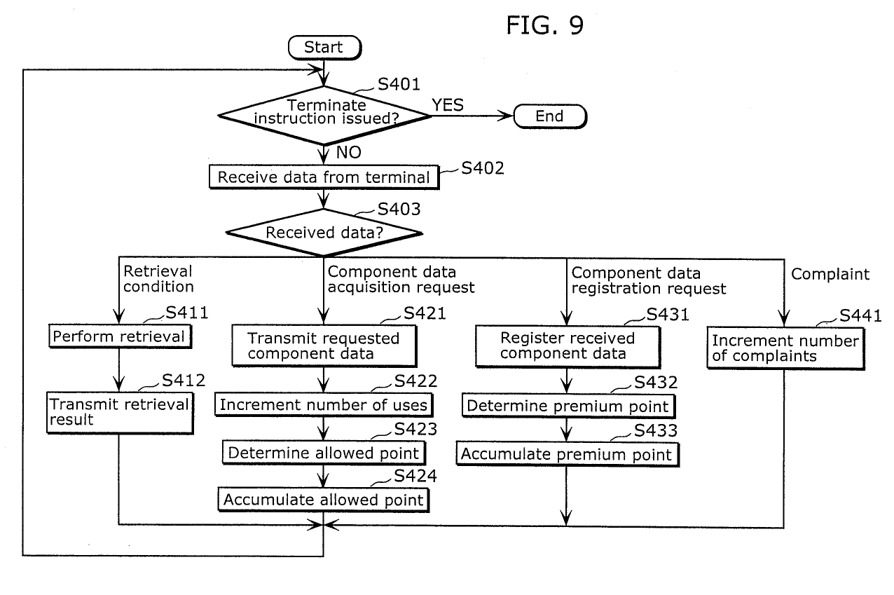

FIG. 9 is the flowchart showing the detailed operation of the server device 10. The flowchart shows the important operation of the server device 10 for processing each request related to the component data from the terminal device 20.

The server device 10 repeats the following processes until an operation terminate instruction is received (NO in S401).

Data is received from the terminal device 20 (S402), and branched depending on the contents of the received data (S403).

When the retrieval condition is received (retrieval condition in S403), the retrieval unit 121 detects one or more pieces of component data matching the retrieval condition received from the component data storage unit 11, and transmits, to the terminal device 20, a component name and a model name of a component mounting device as the identification key of the retrieved component data and the detection result including the corresponding evaluation data (S412).

If there is no component data matching the retrieval condition, for example, the retrieval unit 121 includes the component data of other components having similar component names of the same manufacturer and also the component data matching in shape type in the detection result, thereby extending the retrieval range in a phased manner. Furthermore, the component data of the components of other manufacturers having matching or similar shape types can be included in the retrieval range. Obtaining the component data of similar components as a detection result from a plurality of manufacturers can be useful in quickly obtaining the component data when the similar components of other manufacturers are substituted for the components out of stock.

When a component data acquisition request specifying the component name and the model name of the component mounting device as the identification key of the component data is received (component data acquire request in S403), the component data supply unit 12 acquires, from the component data storage unit 11, the component data identified by the identification key included in the received acquisition request, and transmits the data to the terminal device 20 (S421). At this time, the component data storage unit 11 increments the number of uses of the component data identified by the identification key (S422).

The incentive determination unit 15 refers to the evaluation table shown in FIG. 6B, and determines the incentive point corresponding to the evaluation of the transmitted component data as the imposed point related to acquisition of the component data (S423).

The incentive determination unit 15 records, in the incentive accumulation unit 16, the acquired date and time, the acquirer of the component data, the component name and the model name of the component mounting device as the identification key of the component data, the evaluation data at acquisition, and the imposed point on the acquirer (S424). At this time, the component data supply unit 12 calculates the use fee of the component data from the imposed point recorded in the incentive accumulation unit 16, and transmits to the terminal device 20 the information instructing the payment of the calculated use fee.

When a component data registration request including the component data and the evaluation data is received (component data retrieve request in S403), the component data collection unit 14 stores the component data and the evaluation data included in the received component data registration request in the component data storage unit 11 (S431).

The incentive determination unit 15 refers to the evaluation table sown in FIG. 6B, and determines the difference between the incentive point corresponding to the evaluation of the component data before storage and the incentive point corresponding to the evaluation of the component data after storage as an incentive point related to the registration of the component data (S432). In the determination, for example, when there is the component data matching in the component name but not matching in the model name of the component mounting device before storage of the component data (that is, corresponding to another model of component mounting device), the shape data common among the models of the component mounting device for the component has already been registered. Therefore, the evaluation before storage is set to 1.

If other component data similar to the component data to be registered has already been stored in the component data storage unit 11 when the component data is registered (that is, other similar component data has already been collected), and especially when the evaluation of the similar component data is at the more advanced stage than the evaluation of the component data to be registered before storage (including the stage at which no component data exists), the incentive determination unit 15 can determine the incentive point lower than the case where no similar component data exists.

The similar component data practically refers to the component data of other components having a similar component name of the same manufacturer, the component data of the components of another manufacturer that can be substitutes for the components, the component data matching in shape type, the component data having the same name and different model of the corresponding component mounting device and the like.

What is described above is based on the concept that when similar component data already exists, the operation of generating the component data to be registered can be more easily performed by referring to the similar component data, so as to reduce the actual incentive value related to the generation of the component data.

The incentive determination unit 15 records in the incentive accumulation unit 16 the registration date and time, the provider of the component data, the component name and the model name of the component mounting device as the identification key of the component data, the evaluation data before and after registration, and the incentive point given to the provider (S433).

When a complaint specifying the component name and the model name of the component mounting device as the identification key of the component data is received (complaint in S403), the use data storage unit 122 of the component data supply unit 12 increments the number of occurrences of complaints of the component data identified by the identification key in the component data storage unit 11 (S441).

It is also considered that the incentive point can be given, not immediately after the registration, but after the use data including the number of uses and the number of occurrences of complaints has been collected to some extent. In this case, as an example, evaluation data that belongs to one stage higher can be used if the number of uses exceeds a predetermined threshold, and evaluation data that belongs to one stage lower can be used if the number of occurrences of complaints exceeds a predetermined threshold.

As a variation, for example, when the number of uses exceeds a predetermined threshold by incrementing the number of uses in step S422, a predetermined positive incentive point can be given to the provider of the component data, and when the number of occurrences of complaints exceeds a predetermined threshold by incrementing the number of complaints in step S441, a predetermined negative incentive point can be given to the provider of the component data.

Additionally, the component data supply unit 12 can transmit the component data free of charge to the terminal device 20 in step S421. Thus, providing the component data free of charge can be appealing to users, and the merit of introducing the component mounting device can be appealing to potential clients, thereby improving the sales of the component mounting device.

### <Detailed Operation of Terminal Device>

Operation of the terminal device 20 is described below in detail by referring to a flowchart and a screen display example.

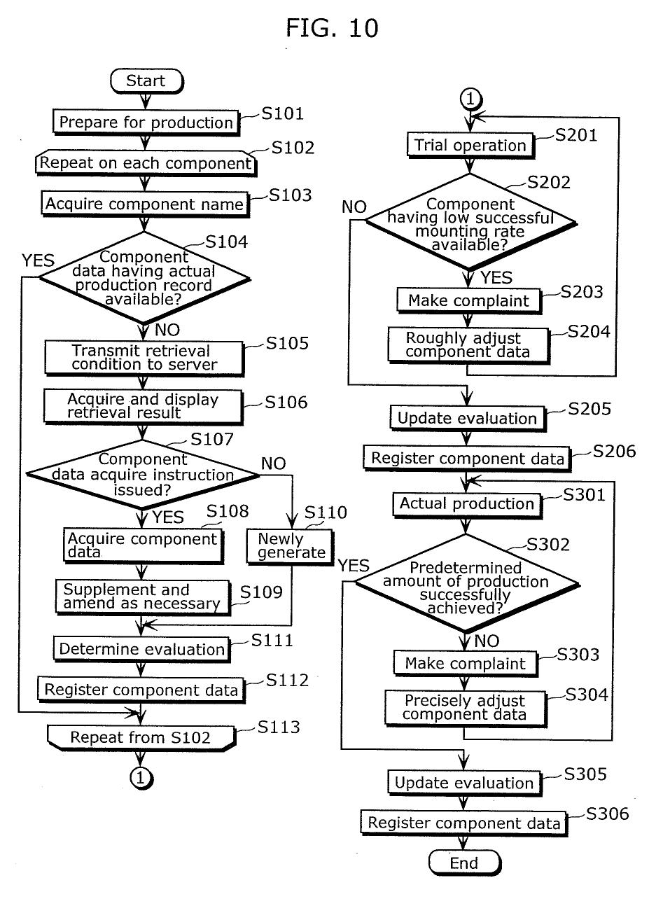

FIG. 10 is a flowchart showing the detailed operation of the terminal device 20. The flowchart shows, as an example of realizing the terminal device 20 as a component mounting device, the important operation related to component data from preparation for production to achievement of actual production.

The terminal device 20 starts preparing for the production including preparation for the component data and NC data (S101). For each component to be mounted on the board, each piece of the component data is prepared by repeating the process up to S113 (S102).

The component providing unit of the mounting mechanism unit 25 reads a component name automatically from a component storage reel or by the operation of an operator (S103). The mounting control unit 21 retrieves, from the component data storage unit 23, the component data with which the read component name and the model name of the component mounting device are identified and in which achievement of actual production by the evaluation data is represented. Without matching component data (NO in S104), the retrieval condition specifying the component name is transmitted to the server device 10 (S105). The mounting control unit 21 displays on the operator I/F unit 22 the retrieval result returned from the server device 10 (S106).

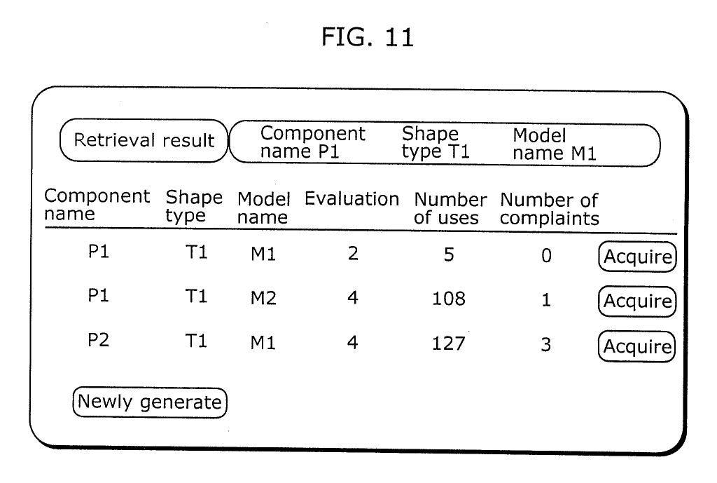

FIG. 11 shows an example of the display screen of a retrieval result. On the display at the upper portion of the screen, the component name related to the component data is P1, and the shape type of the component is T1, and the model name of the component mounting device is M1. The component data matching in component name and model name of the component mounting device only has the evaluation of 2 (mounting data without test production record). As a result of extending the retrieval range in the server device 10, there are retrieval results of the component data having the evaluation of 4 (with actual production record), matching in component name, but not matching in model name of the component mounting device, and the component data matching in shape type but not matching in component name. As the retrieval result, an acquisition button that accepts an acquisition instruction for the component data and a new generation button that accepts a new generation instruction for the component data are shown.

When the acquisition button is touched (YES in S107), the mounting control unit 21 acquires the corresponding component data from the server device 10 and stores it in the component data storage unit 23 (S108).

At this time, the component data supply unit 12 in the server device 10 instructs the terminal device 20 to pay a use fee of the component data, and the terminal device 20 transmits the information for payment of the use fee instructed to the server device 10, thereby performing the payment of the use fee. The use fee of the component data is calculated by multiplying the imposed point recorded when the component data is transmitted by a predetermined fee rate in the server device 10 as described above.

The server device 10 can issue a payment instruction for the use fee of the component data not each time the component data is acquired, but periodically, for example, monthly depending on the accumulation of the incentive points recorded in the period. At this time, when the same user provides the component data, the use fee can also be calculated depending on the amount of offset of the imposed point by the incentive point related to the provision.

The component data input unit 26 supplements or amends the acquired component data according to the input operation by an operator, and updates the component data stored in the component data storage unit 23 with the supplemented or amended component data (S109).

On the other hand, when the new generation button is touched (NO in S107), the component data input unit 26 newly generates component data according to the input operation by an operator, and stores the newly generated component data in the component data storage unit 23 (S110).

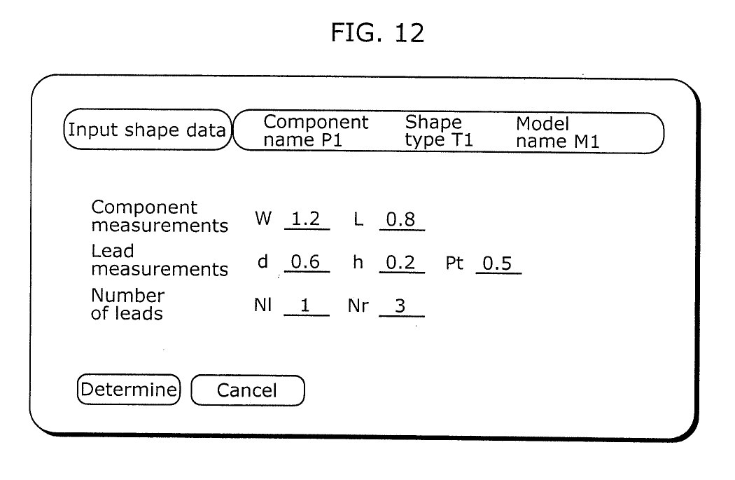

FIG. 12 shows an example of an input screen of shape data. A value is inputted by the keyboard operation of an operator to each item of the shape data displayed on the screen, and when the determination button is touched, the new generation, the supplement, or the amendment contents of the shape data are reflected in the component data storage unit 23.

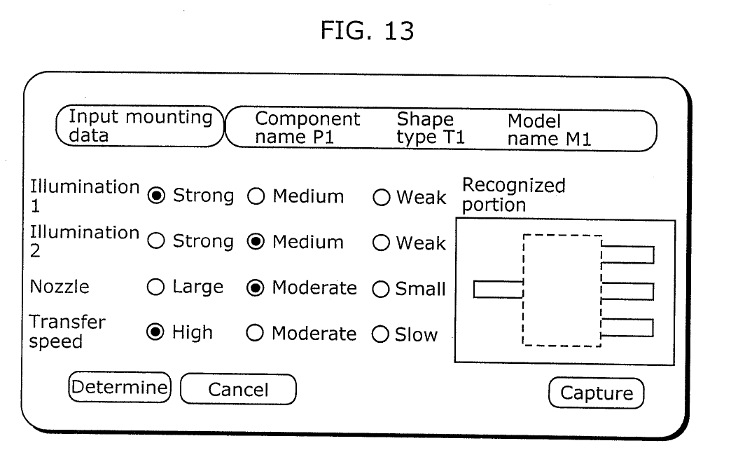

FIG. 13 shows an example of an input screen of mounting data. A value is inputted by the keyboard operation of an operator to each item of the mounting data displayed on the screen, and when the determination button is touched, the new generation, the supplement, or the amendment contents of the shape data are reflected in the component data storage unit 23.

An image of a recognized portion is generated from an image of a component captured by a camera of the mounting mechanism unit 25, and the capturing process is performed by a touch of a capture button. The image of the recognized portion can also be generated from an image of a portion read by an external scanner device as another example, and fetched in by the terminal device 20.

By a touch of the determination button, the contents of the new generation, or the supplement and the amendment are reflected by the component data storage unit 23, and the evaluation determination unit 27 determines evaluation data indicating shape data available if all items of shape data are inputted and indicating mounting data available if all items of mounting data are inputted, and then records the data in the component data storage unit 23 (S111).

The component data registration unit 28 displays on the operator I/F unit 22 the report contents for prompting to register the component data in the server device 10.

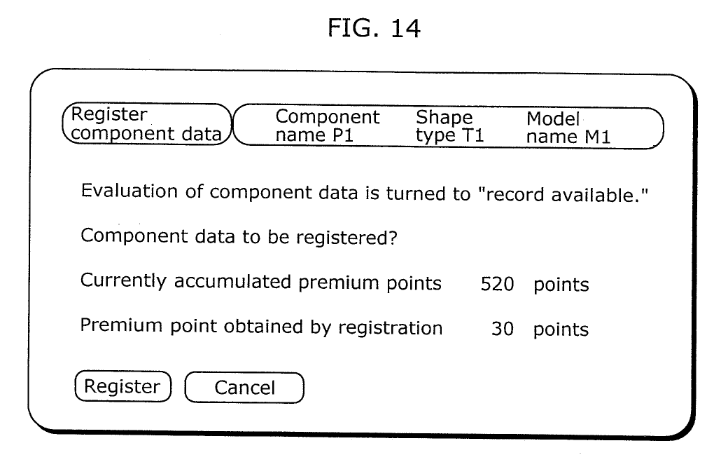

FIG. 14 shows an example of a registration prompt screen of the component data. The determined evaluation data is displayed, and the currently accumulated incentive points and the incentive points obtained by the registration are displayed to prompt the operator to perform the registering operation on the component data.

When the registration button is touched, the component data registration unit 28 registers the component data and the corresponding evaluation data in the server device 10 (S112).

If the preparation for all necessary component data is performed from step S102 to step S113 in the loop process, the mounting control unit 21 controls the mounting mechanism unit 25 to perform test production (S201). At this time, the mounting control unit 21 records the number of trial mounting operations and the number of successful mounting operations in the component data storage unit 23.

If the condition of, for example, the number of successful mounting operations of 20 or more, or the successful mounting rate of 80% or less is satisfied, it is determined that the mounting rate is low (YES in S202), and the complaint transmission unit 212 displays the screen of the contents indicating whether or not a complaint is to be transmitted on the operator I/F unit 22. The transmission of the complaint is generally performed when the component data acquired in step S108 does not successfully function. However, if the component data generated by a user in step S110 and registered in step S112 does not successfully function, then the problem can also be reported by the user.

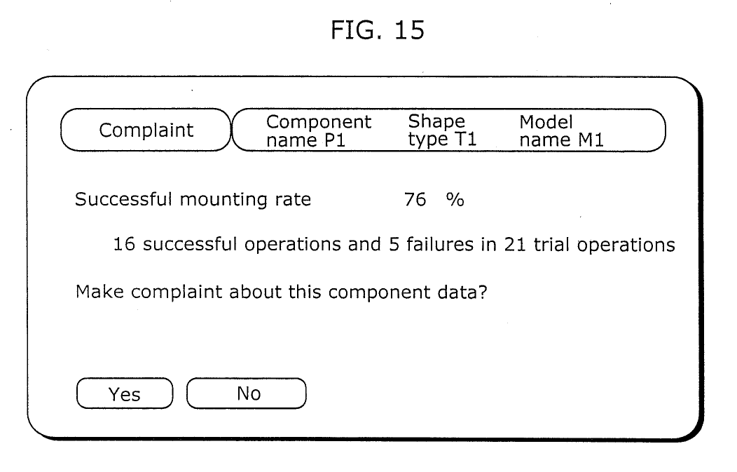

FIG. 15 shows an example of a complaint transmission confirmation screen. The recorded number of trial mounting operations, number of successful mounting operations, successful mounting rate and the like are displayed, and a button for indicating whether or not a complaint is accepted is displayed.

When the button is touched, the complaint transmission unit 212 transmits the complaint data related to the component data to the server device 10 (S203). If a button for transmitting or not transmitting the complaint data is touched, then the component data input unit 26 displays the input screen as shown in FIGS. 12 and 13 on the operator I/F unit 22, and accepts the amended contents of the mounting data. After the component data is roughly amended on the input screen (S204), the test production is performed again.

If it is determined in the test production that there is no component having a low successful mounting rate (NO in S202), then the evaluation determination unit 27 determines again that the evaluation of the component data refers to successful test production, and updates the component data storage unit 23 (S206).

The component data registration unit 28 determines again the evaluation of the registration prompt screen of the component data as shown in FIG. 14 as successful test production, and displays it on the operator I/F unit 22. When the registration button is touched, the component data registration unit 28 registers the component data and the corresponding evaluation data in the server device 10 (S206).

For clarification, the explanation is given above that the evaluation is updated and the component data is registered after all components attain a satisfactory successful mounting rate. However, although components having a low successful mounting rate remain, components that attain a satisfactory successful mounting rate can be sequentially registered with the evaluation of the component data regarded as successful test production.

When the test production is successfully performed, the mounting control unit 21 controls the mounting mechanism unit 25 to achieve actual production (S301). At this time, the mounting control unit 21 determines whether or not the actual production for a predetermined amount has been successfully performed by counting the number of successful production of boards (S302). If it is determined that a predetermined number of production of the boards has not been performed (NO in S302), then a complaint is transmitted depending on the operation by the operator as described above (S303), and the component data is precisely adjusted (S304), and the actual production is continued.

When it is determined that the actual production of the predetermined number of the boards has been successfully performed (YES in S302), the evaluation determination unit 27 determines the evaluation of the component data as successful actual production again, and updates the component data storage unit 23 (S305).

The component data registration unit 28 displays the registration prompt screen of the component data as shown in FIG. 14 on the operator I/F unit 22 with the evaluation regarded as the successful actual production. When the registration button is touched, the component data registration unit 28 registers the component data and the corresponding evaluation data in the server device 10 (S306).

Also in this case, although a predetermined number of the boards has not been successfully performed, fine components that do not interfere with the successful production, that is, only the components correctly mounted on a predetermined number of the boards, can be sequentially registered with the evaluation of the component data regarded as the successful actual production as described above.

In the description up to this point, the terminal device 20 is realized as a component mounting device, but the present invention is not limited to this application. That is, the terminal device 20 can be a computer connected separately from a component mounting device via a communication circuit. In this case, the component data acquired by the terminal device 20 is transmitted to the component mounting device via the communication circuit and used in mounting components, and the information about the status of the test production or the actual production can be transmitted to the terminal device 20 via the communication circuit.

In the description up to this point, the server device 10 is a computer placed at a service location of a component mounting device manufacturer, and the component mounting device manufacturer offers a service of promoting distribution of the component data between clients, that is, users of the component mounting device via the server device 10. However, it is not always necessary that the provider of the service is the component mounting device manufacturer.

For example, in a manufacturer having a number of factories and operating a number of component mounting devices, its production support division can operate the server device 10 to develop the above-mentioned service in the entire corporation.

In this case, for example, a main server can be provided in the production support division, and each factory is provided with a middle server realized as a hierarchical distribution database. If each component mounting device acquires component data from the middle server in each factory provided with the component mounting device, the amount of data of a component library, the amount of communication traffic, and the computational complexity of the server device can be appropriately dispersed. The hierarchical distribution database itself can be configured using a well-known technique.

### <Summary>

As described above, according to the component data distribution method and the component data providing method of the present invention, component data having no record of manufacture of good products and having necessary operations to be performed to achieve actual production can be distributed with evaluation data indicating the operations. Therefore, a user of the component mounting device can check the evaluation data and determine whether or not the component data can be immediately used, to what extent it is necessary to make adjustments to the component mounting device, and so on. Therefore, distribution of the component data can be activated, and the component data can be quickly improved up to the level at which the component data can be used for the manufacture of good products. Provision of the component data can be promoted by the incentive depending on the evaluation and the use situation.

Thus, since the component data with various levels of evaluation is collected and distributed by a server device as a component data distribution apparatus, there is an increasing number of opportunities for a component mounting device to acquire available component data. An operator can select and acquire component data with necessary evaluation by confirming the evaluation of the component data to be acquired when the operator acquires the component data.

As a result, operation of adjusting the component data by trial and error, and operation of improving the component data by an analysis of a problem can be reduced. Therefore, the production resources required in the trial step up to the manufacture of good products can be optimized. The optimization of the production resources corresponds to the reduction of, for example, the number of working steps of operators, electric power, fuels, water, sample materials and the like.

Furthermore, using component data with desirable evaluation (that is, data well-examined and completed at a high level) acquired from a server device in the component mounting device, the quality of a product manufactured in a step of manufacture of good products can be enhanced. As a result, the product itself needs reduced power consumption and has extended durability, thereby contributing to socially required energy- and resource-saving.

### <Supplement>

The component data distribution system according to the present invention is described above, but the present invention is not limited to the above-mentioned embodiment of the present invention. Within the scope of the gist of the present invention, variations applied to the embodiment of the present invention as anticipated by those skilled in the art are included in the scope of the present invention.

For example, in the embodiment of the present invention, a user that the component data registered (provided) is disclosed to is not limited. However, the present invention is not limited to this application, but regarding the component data generated by a provider and registered in the server device 10, the following restriction can be applied to the user that the component data is disclosed to.

That is, when each user makes a contract to participate in a component data distribution system, a user group to which the user belongs is recorded. When the user searches component data, a component name of the component data registered by another user in a user group different from the group of the above-mentioned user is excluded from the detection result. The disclosure restriction of the component data can be specified for each component name, or can be specified using a list of user groups to which the disclosure is permitted.

As a practical configuration, for example, a user group table is provided in the server device 10, and a user name is stored in advance in the user group table. The user group table is stored in which the user group name is associated with the user name included in the user group. A user group refers to, for example, a group of corporations having any relationship of a related company and the like.

The terminal device 20 accepts, from a provider of the component data, an operation of specifying the scope of disclosure of the component data generated by the provider of the component data for each component name. The provider of the component data specifies no restriction of the scope of disclosure of the component data considered not to cause much trouble in generating the data based on component shape, but can specify a restriction on the scope of disclosure of the component data, for example, a multiple pin component and the like that cause much trouble in generation.

The terminal device 20 transmits, to the server device 10, the component data with the information about the scope of disclosure specified by the provider. The server device 10 records, in the component data storage unit 11, the component data with the information about the scope of disclosure.

When the retrieval unit 121 receives a retrieval condition from the terminal device 20, it excludes the component data having a component name whose information about the restriction on the scope of disclosure is recorded from the retrieval result if the data is registered by a user in a user group different from the user who issues the retrieval condition.

Since the component data excluded from the retrieval result is not displayed on the terminal device 20, the component data cannot be requested from the terminal device 20 for acquisition. As a result, a component data providing step of providing the component data only for a user in a range set by a provider of the component data is realized.

The user group is not only used in restricting the scope of disclosure of the component data, but also used in determining the use fee of the component data imposed when the component data is acquired.

In the embodiment of the present invention, determining the point obtained by multiplying an imposed point by a predetermined fee rate is described. The fee rate can be set higher when, for example, a user who acquires the component data belongs to a user group different from a group of a provider of the component data than when they belong to the same group.

With the above-mentioned configuration, the provider of the component data prohibits the disclosure of the component data to the user in the different user group, but there can be a possibility that a higher fee can be obtained from the user in the different user group.

The component data distribution apparatus according to the present invention can also be realized as a computer system.

In this case, the computer system for realizing the component data distribution system according to the present invention includes a CPU, ROM storing a program determining procedure for distributing the component data to be used by a component mounting device when a component is mounted on a board, RAM for holding working data, a large capacity storage unit, and a communication unit for communicating with a component data providing device and a component data receiving device. Under the control performed by the CPU executing the program stored in the ROM using the RAM, the communication unit can receive, from the component data providing device, the component data and evaluation data indicating a degree of a necessary operation required to achieve actual production using the component data, and the large capacity storage unit can accumulate the received component data with the received evaluation data to provide the received component data for the component data providing device.

With the above-mentioned configuration, the component data distribution apparatus can be realized as a computer system that operates under the control of predetermined software.

### INDUSTRIAL APPLICABILITY

The component data distribution method according to the present invention can be used for a server device provided in a service location of a component mounting device and a factory where the component mounting device is installed, and the component data providing method can be used for the component mounting device itself.

1. A component data distribution method which is executed by a component data distribution apparatus and allows distribution of component data to be used by a component mounting device when a component is mounted on a board, said method comprising:
collecting, from a component data providing device, component data and evaluation data indicating a degree of an operation required to achieve actual production using the component data; and
accumulating the collected component data with the collected evaluation data so as to provide the collected component data for a component data receiving device.

2. The component data distribution method according to claim 1,
wherein the component data includes a portion common to a plurality of component mounting devices, and a plurality of portions individualized to the plurality of component mounting devices; and
in said collecting, the component data is collected with a plurality of pieces of evaluation data individualized to the plurality of component mounting devices.

3. The component data distribution method according to claim 1, further comprising
determining an incentive by judging the operation required to achieve the actual production based on contents indicated by the evaluation data.

4. The component data distribution method according to claim 1,
wherein the component data providing device is realized as the component mounting device; and
in said collecting, component data having a production record in the component mounting device is collected by the component data distribution apparatus by issuing, to the component mounting device, a notification for prompting a provision of the component data having the production record.

5. The component data distribution method according to claim 1, further comprising:
retrieving, when a retrieval condition is provided from the component data receiving device, one or more pieces of component data from among the collected component data in accordance with the provided retrieval condition, and transmitting, to the component data receiving device, a retrieval result including a component name specifying each piece of retrieved component data and corresponding evaluation data; and
providing, for the component data receiving device, component data specified by a given component name, when the component data receiving device provides an acquisition request with one or more components' names specified and included in the retrieval result.

6. The component data distribution method according to claim 1,
wherein the component data receiving device is realized as the component mounting device;
said component data distribution method further comprising
providing the component mounting device with the component data in accordance with an acquisition request transmitted from the component mounting device when the components are collated.

7. The component data distribution method according to claim 1, further comprising
notifying the component data receiving device of a use fee payment instruction based on the collected evaluation data of the collected component data when the collected component data is provided for the component data receiving device.

8. The component data distribution method according to claim 1, further comprising
providing the collected component data for only a user in a scope set by a provider of the component data.

9. A component data distribution apparatus which supports distribution of component data for use in a component mounting device when a component is mounted on a board, said apparatus comprising:
a component data collecting unit operable to collect, from a component data providing device, component data and evaluation data indicating a degree of an operation required to achieve actual production using the component data; and
a component data accumulating unit operable to accumulate the collected component data with the collected evaluation data to provide the collected component data for a component data receiving device.

10. A program which causes a computer to execute collecting and accumulating included in a component data distribution method which is executed by a component data distribution apparatus and allows distribution of component data to be used by a component mounting device when a component is mounted on a board,
wherein said method includes:
said collecting, from a component data providing device, component data and evaluation data indicating a degree of an operation required to achieve actual production using the component data; and
said accumulating the collected component data with the collected evaluation data so as to provide the collected component data for a component data receiving device.
